(19) United States
(12) Patent Application Publication
(10) Pub. No.: US 2018/0367042 A1
(43) Pub. Date: Dec. 20, 2018

(54) RESONANT POWER CONVERTER COMPRISING ADAPTIVE DEAD-TIME CONTROL

(71) Applicant: Danmarks Tekniske Universitet, Kgs. Lyngby (DK)

(72) Inventors: Thomas Andersen, Valby (DK); Tiberiu-Gabriel Zsurzsan, Kgs. Lyngby (DK); Marzieh Ekhtiari, Frederiksberg (DK)

(21) Appl. No.: 15/741,466

(22) PCT Filed: Jun. 14, 2016
(86) PCT No.: PCT/EP2016/063582

§ 371 Date: Jan. 2, 2018

(30) Foreign Application Priority Data
Jun. 30, 2015 (EP) 15174592.4

(51) Int. Cl. H02M 3/337; H02M 1/36; H02M 3/335

(52) U.S. Cl. CPC H02M 3/3376; H02M 2001/0058; H02M 3/33507; H02M 1/36

(57) ABSTRACT

The invention relates in a first aspect to a resonant power converter comprising: a first power supply rail for receipt of a positive DC supply voltage and a second power supply rail for receipt of a negative DC supply voltage. The resonant power converter comprises a resonant network with an input terminal for receipt of a resonant input voltage from a driver circuit. The driver circuit is configured for alternatingly pulling the resonant input voltage towards the positive and negative DC supply voltages via first and second semiconductor switches, respectively, separated by intervening dead-time periods in accordance with one or more driver control signals. A dead-time controller is configured to adaptively adjusting the dead-time periods based on the resonant input voltage.

The invention relates in a first aspect to a resonant power converter comprising a first power supply rail for receipt of a positive DC supply voltage and a second power supply rail for receipt of a negative DC supply voltage. The resonant power converter comprises a resonant network with an input terminal for receipt of a resonant input voltage from a driver circuit. The driver circuit is configured for alternatingly pulling the resonant input voltage towards the positive and negative DC supply voltages via first and second semiconductor switches, respectively, separated by intervening dead-time periods in accordance with one or more driver control signals. A dead-time controller is configured to adaptively adjusting the dead-time periods based on the resonant input voltage.

### BACKGROUND OF THE INVENTION

A sub-group of resonant power converter comprises a piezoelectric transformer as a resonant circuit or resonant tank. Piezoelectric power converters are a viable alternative to traditional magnetics based resonant power converters in numerous voltage or power converting applications such as AC/AC, AC/DC, DC/AC and DC/DC power converter applications. Piezoelectric power converters are capable of providing high isolation voltages and high power conversion efficiencies in a compact package with low EMI radiation. The piezoelectric transformer is normally operated in a narrow frequency band around its fundamental or primary resonance frequency with a matched load coupled to the output of the piezoelectric transformer. The optimum operating frequency or excitation frequency shows strong dependence on different parameter such as temperature, load, fixation and age. So-called zero-voltage-switching (ZVS) operation, or soft-switching, of a driver circuit, coupled to the input terminal of a resonant network, which may comprise a piezoelectric transformer, may be achieved via the intrinsic input impedance characteristics of the resonant network or may be achieved by coupling an external inductor in series or parallel with the output signal supplied by the driver circuit. In both cases an input impedance of the resonant network may appear inductive across a relatively large frequency range such that capacitances at the output of the driver circuit can be alternatingly charged and discharged by resonant current during dead-time periods of the driver circuit without inducing prohibitive power losses. The driver circuit may comprise a half-bridge or full-bridge MOS transistor circuit.

For obtaining the desired zero voltage switching (ZVS), a dead-time period or interval (DT) of the driver circuit needs to be sufficiently large to allow charging and discharging of the input terminal of the resonant network. The present inventors have discovered that a dead-time period shorter than required for zero voltage switching causes hard switching of the driver circuit. Likewise, a dead-time period longer than required for zero voltage switching may either cause hard switching of the driver circuit or may cause soft switching of the driver circuit with sub-optimum efficiency. However, prior art resonant power converters have been provided with a fixed dead-time period, for example tailored to characteristics of a particular piezoelectric transformer at fixed operating conditions. The fixed dead-time period is unable to account for manufacturing tolerances and drift of active and passive electronic components of the resonant power converter, in particular those of a piezoelectric transformer.

Hence, the use of fixed dead-time period leads to increased power consumption of practical resonant power converters where the above-mentioned manufacturing tolerances and drift of active and passive electronic components are inevitable.

Hence, it would be advantageous to provide adjustable dead-time periods of appropriate length or duration to secure zero voltage switching of the driver circuit of a resonant power converter, including piezoelectric power converters, for the purpose of minimizing power losses or optimizing energy conversion efficiency.

### SUMMARY OF THE INVENTION

A first aspect of the invention relates to a resonant power converter comprising:

a first power supply rail for receipt of a positive DC supply voltage and a second power supply rail for receipt of a negative DC supply voltage,

a resonant network comprising an input section and an output section wherein the input section comprises an input terminal for receipt of a resonant input voltage and the output section comprises an output terminal for providing a resonant output voltage in response to the resonant input voltage,

a driver circuit comprising a first semiconductor switch coupled to the positive DC supply voltage and a second semiconductor switch coupled to the negative DC supply voltage and a driver output connected to the input terminal for supply of the resonant input voltage;

wherein the driver circuit is configured for alternatingly pulling the resonant input voltage towards the positive and negative DC supply voltages via the first and second semiconductor switches, respectively, separated by intervening dead-time periods in accordance with one or more driver control signals,

a dead-time controller configured to adaptively adjusting the dead-time periods based on the resonant input voltage.

The dead-time controller is able to provide adequate length or duration of the dead time periods of the driver circuit to deliver sufficient energy for charging and discharging the input capacitance at the input terminal of the resonant network—for example an input electrode of a piezoelectric transformer. This feature enables zero voltage switching (ZVS) and/or zero current switching (ZCS) of the driver circuit such that energy consumption involved in the switching activity of the first and second semiconductor switches of driver circuit is minimized.

According to one embodiment of the resonant power converter, the dead-time controller is configured to independently adjust low to high dead time periods and high to low dead time periods. The skilled person will understand that the resonant input voltage transits from the positive DC supply voltage to the negative DC supply voltage during the high to low dead time period. The resonant input voltage furthermore transits from the negative DC supply voltage to the positive DC supply voltage during the low to high dead time period as discussed in further detail below with reference to the appended drawings.

The independent adjustment of the low to high dead time periods and high to low dead time periods is an advantageous feature, because experimental results show that the optimum setting of these dead-times may differ markedly. This difference in optimum dead time settings is inter alia caused by different electrical characteristics, e.g. on-resistance and parasitic capacitance, of the first and second semiconductor switches and differences of capacitance loading at the input terminal of the resonant network.

According to one such embodiment the dead-time controller is configured to independently adjust the low to high dead time period and high to low dead time period of each switching cycle of the resonant input voltage or at least during a majority of the switching cycles.

The dead-time controller of the resonant power converter may utilize various features of the resonant input voltage for detecting an optimum dead time period and adaptively adjusting the dead-time period. The dead-time controller may be configured to independently adjust the high to low dead-time period and low to high dead time period during every switching cycle, or at least the majority of switching cycles for example more than 75% of the switching cycles, of the resonant input voltage based on an instantaneous value thereof. The switching cycle is determined by a switching frequency of the resonant power converter. Alternatively, the dead-time controller may be configured to adjust the high to low dead-time periods and the low to high dead time periods during a specific operating condition of the power converter for example solely during a start-up phase or initialization time of the resonant network or solely during steady state operation of the resonant network as discussed in further detail below with reference to the appended drawings. The adaptive adjustment of the dead-time periods may hence result in a decrease of energy loss and consequently increased energy efficiency of the resonant power converter both during the start-up phase and during steady state operation of the resonant power converter.

If the resonant network comprises a piezoelectric transformer which may possess a zero-voltage-switching factor (ZVS factor) larger than 100%, preferably larger than 120%, such as larger than 150% or 200%. This means the piezoelectric transformer possesses native ZVS properties or characteristics as discussed in further detail for example in U.S. patent application Ser. No. 14/237,432. A number of highly useful piezoelectric transformers suitable for application in the present piezoelectric power converters with high power conversion efficiencies and native ZVS properties are disclosed in European patent application No. 11176929.5.

The driver circuit may comprise a half-bridge or H-bridge driver. The half-bridge driver circuit may comprise a first semiconductor switch and a second semiconductor switch coupled in series between the positive DC supply voltage and the negative DC supply voltage. A midpoint node between the first and second semiconductor switches may be deliver the driver output voltage or signal to the input terminal of the resonant network such as an input electrode or electrodes of a primary/input section of the piezoelectric transformer. Each of the first and second semiconductor switches may comprise a MOSFET for example a DMOS, PMOS or NMOS device. Each of the first and second semiconductor switches further comprises a control terminal or input such as a gate terminal for receipt of the driver control signal. A first driver control signal of the first semiconductor switch is configured to switch the first semiconductor switch between a conducting/ON state and a non-conducting/OFF state. A second driver control signal of the second semiconductor switch is likewise configured to switch the second semiconductor switch between a conducting/ON state and a non-conducting/OFF state. The first and second driver control signals are preferably non-overlapping such that the first semiconductor switch pulls the resonant input voltage towards the positive DC supply voltage via its relatively small on-resistance in the conducting state and the second semiconductor switch after the intervening dead-time period pulls the resonant input voltage towards the negative DC supply voltage via its relatively small on-resistance in the conducting state. Hence, during the dead time periods the resonant input voltage or signal is alternatingly charged and discharged from, the positive DC supply voltage to the negative DC supply voltage and vice versa by resonant current flowing through an intrinsic input impedance of the piezoelectric transformer and/or by resonant current flowing through, or out of, a series inductor of the resonant network as discussed in further detail below with reference to the appended drawings. The resonant input signal is clamped to the positive DC supply voltage in a first time period where the first semiconductor switch is conducting and the second semiconductor switch non-conducting. Likewise, the resonant input signal is clamped to the negative DC supply voltage in a second time period where the second semiconductor switch is conducting and the first semiconductor switch non-conducting.

Hence, according to one embodiment of the resonant power converter, the first semiconductor switch comprises a conducting state where the input terminal is connected to the positive DC supply voltage and the second semiconductor switch comprises a conducting state where the input terminal is connected to the negative DC supply voltage; and where the first semiconductor switches is in a non-conducting state during the dead-time periods and the second semiconductor switch is in a non-conducting state during the dead-time periods.

The switching frequency of the resonant power converter may lie between 75 kHz and 500 kHz such as between 100 kHz and 150 kHz. The resonant power converter may comprise a feedback loop which induces self-oscillation of the resonant power converter. The feedback loop ensures that the switching or excitation frequency automatically tracks changing characteristics of a piezoelectric transformer and electronic circuitry of the input side of the power converter.

According to one embodiment, the dead-time controller utilizes a level or amplitude of the instantaneous resonant input voltage to detect the respective time instant to switch the first semiconductor switch to its conducting state or on-state and thereby terminate the low to high dead time period. Likewise, the dead-time controller utilizes the level or amplitude of the instantaneous resonant input voltage to detect the time instant to switch the second semiconductor switch to its conducting state or on-state and thereby terminate the high to low dead time period. According to another embodiment, the dead-time controller utilizes a waveform shape of the instantaneous resonant input voltage to detect the respective time instants or phases at which to switch the first or second semiconductor to the conducting state as discussed in further detail below with reference to the appended drawings.

The dead-time controller may be configured to adjust a phase or timing of the first driver control signal of the first semiconductor switch to adaptively adjust the duration of the low to high dead time period and a phase or timing of the second driver control signal of the second semiconductor switch to adaptively adjust the duration of the high to low dead time period as discussed in further detail below with reference to the appended drawings.

The dead-time controller may comprise a steady-state controller configured to adjust the high to low dead time period and the low to high dead time period during steady state operation of the resonant power converter. One embodiment of the tsteady-state controller comprises: a first comparator configured to compare the instantaneous resonant input voltage to the positive DC supply voltage and supply a first comparator output signal (Z_{HS}) for adjusting the phase of the first driver control signal in accordance with the first comparator output signal. A second comparator of the steady-state controller may be configured to compare the instantaneous resonant input voltage to the negative DC supply voltage and supply a second comparator output signal (Z_{LS}) for adjusting the phase of the second driver control signal in accordance with the second comparator output signal.

The dead-time controller may comprise a start-up controller configured to detect a waveform shape of the instantaneous resonant input voltage; and

generating a first control signal (Z_{MH}) for adjusting the phase of the first driver control signal in accordance with the waveform shape; and/or

generating a second control signal (Z_{ML}) for adjusting the phase of the second driver control signal in accordance with the waveform shape.

The start-up controller may be configured to detect the waveform shape of the resonant input voltage by comparing the instantaneous resonant instantaneous transformer input voltage with a delayed replica of the resonant input voltage as discussed in further detail below with reference to the appended drawings. The waveform shape of the resonant input voltage may be utilized by the dead-time controller to detect a local maximum of the waveform of the instantaneous resonant input voltage in response to the delayed replica of the resonant input voltage exceeds the instantaneous resonant input voltage; and/or

detect a local minimum of the waveform of the instantaneous resonant input voltage in response to the delayed replica of the resonant input voltage falls below the instantaneous resonant input voltage.

The dead-time controller may be configured to limit the instantaneous resonant input voltage between a lower threshold voltage and an upper threshold voltage before detecting the local maximum and/or detecting the local minimum. The lower threshold voltage may for example lie between 0.05 and 0.45 times the positive DC supply voltage such as between 0.05 and 0.2 times the positive DC supply voltage. The upper threshold voltage may lie between 0.55 and 0.95 times the positive DC supply voltage, such as between 0.55 and 0.95 times the positive DC supply voltage, if the negative DC supply voltage is ground or zero volt.

The dead-time controller may comprise a first digital OR circuit configured to logically OR the first comparator output signal and the first control signal; and a second digital OR circuit configured to logically OR the second comparator output signal and the second control signal.

As discussed above, the driver circuit and the resonant network are preferably configured for ZVS operation or ZCS operation at the switching frequency of the resonant power converter to charge and discharge the resonant input voltage during the dead-time periods with minimal power consumption.

As discussed previously, the resonant network may comprise a piezoelectric transformer wherein the primary or input section of the piezoelectric transformer is coupled to the resonant input voltage to supply a transformer input voltage. The secondary section of the piezoelectric transformer may generate the resonant output voltage.

The skilled person will understand that any of the previously described embodiments of the resonant power converter may comprise a rectification circuit coupled to the resonant output voltage of the resonant network. The resonant output voltage may comprise an output signal of the secondary side of an isolation, step-up or step-down transformer of the resonant power converter such as the piezoelectric transformer. The rectification circuit may comprise a half-wave rectifier or a full-wave rectifier.

A second aspect of the invention relates to a method of adaptively controlling a dead-time interval of a driver circuit of a resonant power converter. The method may comprise steps of:

generating first and second non-overlapping driver control signals for the driver circuit in accordance with a switching frequency of the resonant power converter,

wherein the driver circuit is coupled between positive and negative DC supply voltages for supply of power,

applying the first and second non-overlapping driver control signals to the driver circuit to generate a driver output signal alternating between the positive DC supply voltage and negative DC supply voltage separated by intervening low to high dead time periods and high to low dead time periods,

applying the driver output voltage to an input section of the resonant network to generate a resonant input voltage,

generating a resonant output voltage in response to the resonant input voltage at an output section of the resonant network,

detecting a feature of the resonant input voltage,

adjusting durations of the low to high dead time periods based on the detected feature of the resonant input voltage and independently adjusting durations of the high to low dead time periods based on the detected feature of the resonant input voltage.

The method may comprise detecting the instantaneous resonant input voltage during each switching cycle of the switching frequency of the resonant power converter and independently adjusting the low to high dead time period and the high to low dead time period ted accordingly in response. Other embodiments may be configured to independently adjusting the low to high dead time period and/or the high to low dead time period less frequently for example during every second, third or fourth switching cycle of the resonant input voltage.

The method may further comprise adjusting a phase of a first driver control signal of the first semiconductor switch to adjust the low to high dead time period; and adjusting a phase of a second driver control signal of the second semiconductor switch to adjust the high to low dead time period.

### BRIEF DESCRIPTION OF THE DRAWINGS

Preferred embodiments of the invention are described in more detail in connection with the appended drawings, in which:

FIG. 1 shows a simplified schematic block diagram of a prior art piezoelectric power converter,

FIGS. 1A, 1B and 1C show respective plots of equivalent circuits and resonant current flow of the piezoelectric transformer of the piezoelectric power converter during eight separate time sub-intervals of a switching cycle,

FIG. 2A) shows corresponding waveforms of transformer input voltage and resonant current during one switching cycle of the prior art piezoelectric power converter in steady state operation where ZVS is achieved,

FIG. 2B) shows corresponding waveforms of transformer input voltage and resonant current during one switching cycle of the prior art piezoelectric power converter in steady state operation where ZVS is achieved,

FIG. 3A) shows a first example of corresponding waveforms of the transformer input voltage and resonant current during one switching cycle of the prior art piezoelectric power converter during a start-up phase or period of the converter,

FIG. 3B) shows a second example of corresponding waveforms of the transformer input voltage and resonant current during one switching cycle of the prior art piezoelectric power converter in steady state operation,

FIG. 4A) shows corresponding waveforms of the resonant input voltage and resonant current during one switching cycle of a resonant power converter, based on a piezoelectric transformer, in accordance with a first embodiment of the invention in steady state operation where the dead-time period is optimum and ZVS is achieved,

FIG. 4B) shows corresponding waveforms of the resonant input voltage and resonant current during one switching cycle of the piezoelectric power converter in accordance with the first embodiment during a start-up phase or period where the dead-time period is optimum,

FIG. 5 is a simplified schematic circuit diagram of the resonant power converter in accordance with the first embodiment of the invention,

FIG. 5A is a simplified schematic circuit diagram of a resonant power converter based on a LCC power converter in accordance with a second embodiment of the invention,

FIG. 6 is a schematic block diagram of a preferred embodiment of the dead-time controller of the first and second embodiments of the resonant power converter; and

FIG. 7 shows experimentally measured normalized voltage and current waveforms of the transformer input voltage and resonant current of the piezoelectric power converter captured through several switching cycles of the start-up phase and corresponding waveforms of a prior art piezoelectric power converter.

### DETAILED DESCRIPTION OF PREFERRED EMBODIMENTS

The below-appended description of preferred embodiments of the piezoelectric power converters uses the following:

Nomenclature:

V_{F}: Transformer input voltage or switching voltage.

iᵣₑₛ: Resonant current of piezoelectric transformer.

Iₚₖ: Peak value of the resonant current of the piezoelectric transformer.

ω: Switching angular frequency.

Cd1: Input electrode capacitance of the piezoelectric transformer.

Cd2: Output electrode capacitance of the piezoelectric transformer.

R: Dielectric losses inside the piezoelectric transformer.

C: Resonant capacitance of the piezoelectric transformer.

L: Internal inductance of the piezoelectric transformer.

Cₒₛₛ: Output capacitance of MOSFETs of a driver circuit.

Cᵢₙ: Equivalent input capacitance of the piezoelectric transformer attached to a driver circuit.

DT: Dead time.

ODT: Optimum dead time.

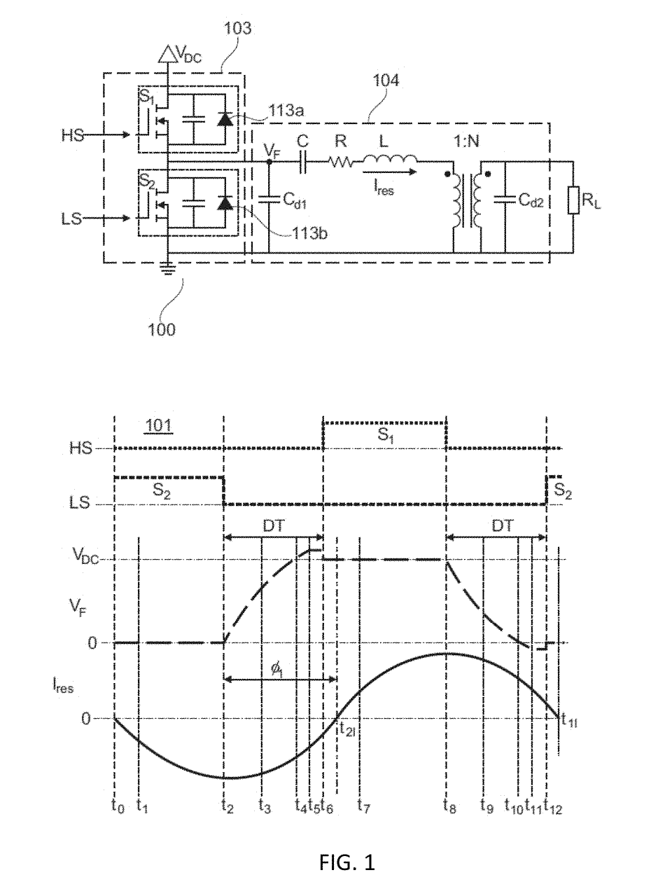

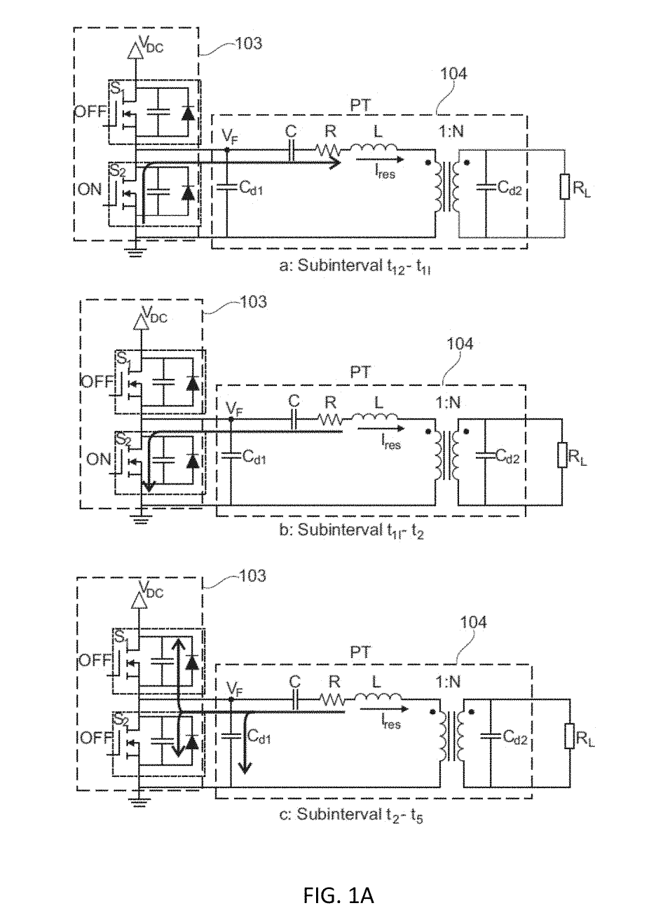

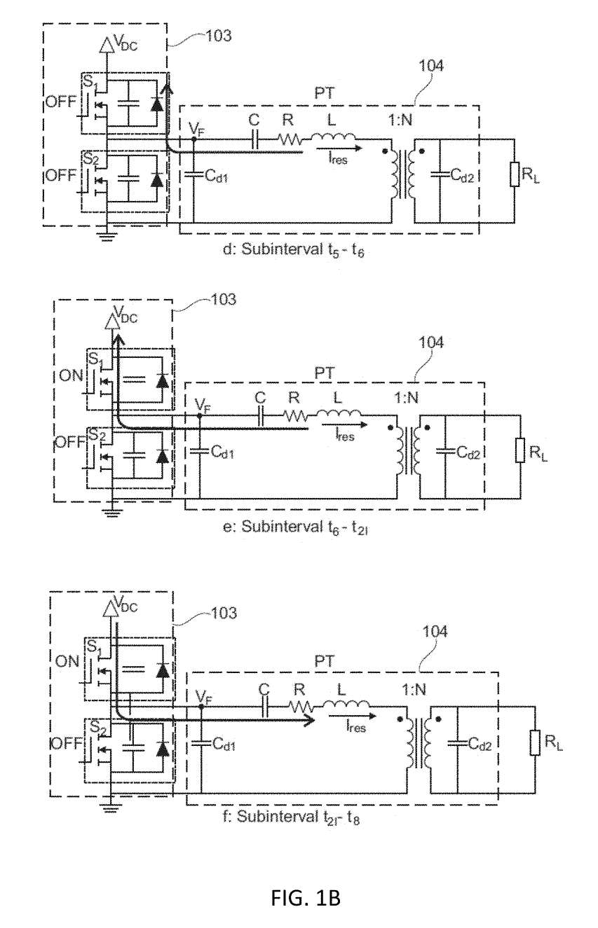

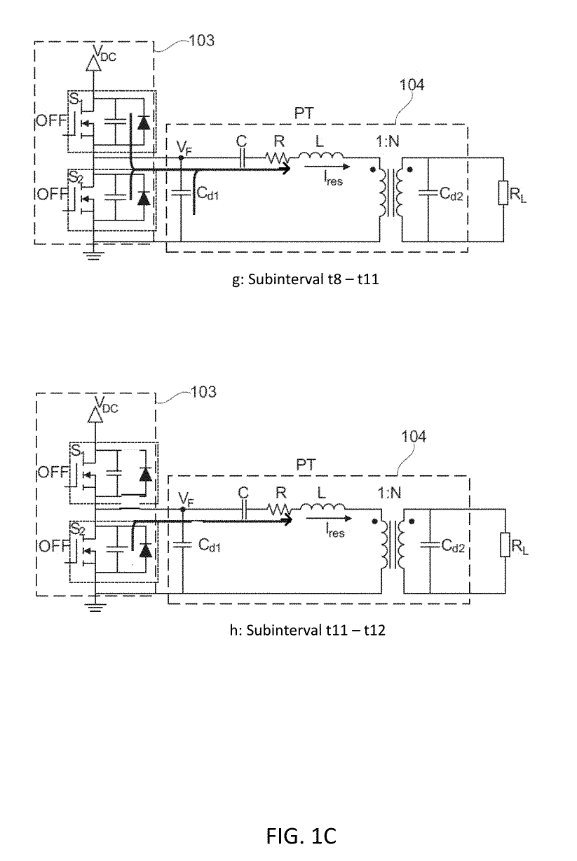

FIG. 1 shows a simplified schematic block diagram of a prior art resonant power converter 100 based on a piezoelectric transformer 104. The piezoelectric transformer, PT, 104 is represented by a simplified equivalent electric circuit diagram inside box 104. A lower waveform plot 101 of FIG. 1 shows various voltage and current waveforms of the prior art piezoelectric power converter 100 during operation at a certain switching or excitation frequency as discussed in further detail below. The piezoelectric power converter 100 additionally comprises an input driver circuit 103 electrically coupled to an input electrode of the piezoelectric transformer 104 for receipt of transformer input voltage V_{F}. Hence, the transformer input signal applies an ac input drive signal to the input or primary section of the piezoelectric transformer 104. A driver control circuit (not shown) may be generating appropriately timed gate control signals for NMOS transistors S₁ and S₂ of the input driver 103. A second input electrode of the piezoelectric transformer 104 may be connected to a negative DC supply rail such as ground, GND, as illustrated. An electrical load R_{L} may be coupled between a pair of output electrodes of the piezoelectric transformer 104. The pair of pair of output electrodes is electrically coupled to a secondary or output section of the piezoelectric transformer 104 as indicated by the 1:N transformer symbol.

In piezoelectric power converters switches are normally semiconductor devices such as MOSFETs with a build-in delay time. This delay time applies to a gate drive signal to start up a switching of the state of the semiconductor switch. Typically, the turn on and turn off delay time of the semiconductor switch differs. Therefore, an amount of delay is given to the gate drive signal to prevent simultaneous conducting states on of the semiconductor switches. Therefore, a dead time period or interval is usually defined as a time interval during a switching transition where both semiconductor switches, e.g. MOSFETs, are in non-conducting states, i.e. turned off. A driver circuit with a half-bridge topology, coupled to an input electrode of the piezoelectric transformer, should preferably have a dead-time period arranged in-between the conducting state periods of the semiconductor switches in order to avoid cross-conduction or shoot through between the semiconductor switches. In piezoelectric power converters, the semiconductor switches of the driver circuit need to supply reactive energy to an input capacitor or capacitance associated with the primary section of the piezoelectric transformer. However, the dead-time period provides appropriate time for charging and discharging this input capacitance of the primary section of the piezoelectric transformer. In contrast only MOSFET's output capacitances need to be charged by resonant current of LCC resonant power converters. These MOSFET's output capacitances are typically around hundreds of pF.

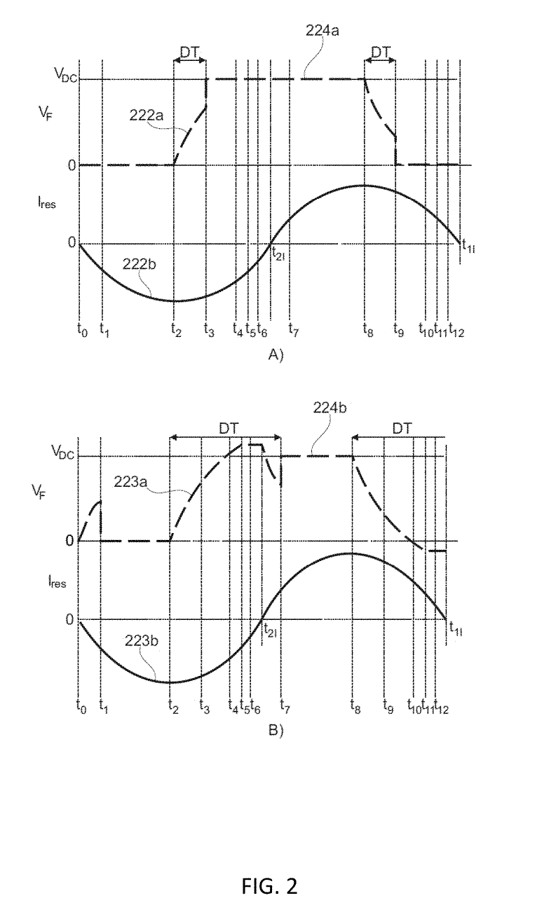

In piezoelectric power converters, the output capacitances of the semiconductor switches and the input capacitance associated with the primary section of the piezoelectric transformer must be charged by resonant current to raise the resonant input voltage at input electrode from the negative DC supply voltage or rail, e.g. ground 0 (V), to the positive DC supply voltage or rail as previously discussed. Since the input capacitance associated with the primary section of the piezoelectric transformer is normally in the range of nF it requires longer time for the resonant current to provide enough charge to the capacitances. Hence, the dead-time of the input driver of a piezoelectric power converter is normally longer or larger than the dead-time of the input driver of a LCC resonant converter. It is often advantageous to keep the dead-time of the input driver of a piezoelectric power converter as short as possible in order to increase power conversion efficiency. Furthermore, this feature will prolong injection of energy to the piezoelectric transformer during turn on time of a high side switch pulling the input the output of the driver circuit towards the positive DC supply voltage. The behaviour of input inductor less piezoelectric power converters where ZVS operation of the input driver circuit is achieved is analysed in the following with reference to the different operating modes illustrated on the plots of FIGS. 1A, 1B and 10. The present analysis is generally carried out for 8 different operating modes which are divided into 4 intervals. Each of these 4 intervals comprises 2 subintervals as discussed below. Therefore, voltage waveforms of the transformer input voltage V_{F} through a switching cycle of the input voltage are shown as t₀−t₁₂ with respect to V_{F}. FIG. 2 shows both the transformer input voltage V_{F} and corresponding resonant current Iᵣₑₛ waveforms during one switching cycle in steady state of the piezoelectric power converters where ZVS operation is achieved. The plots a-h of FIGS. 1A), 1B) and 1C) show eight different operating modes. The below-appended analysis is based on the following three assumptions:

1) The converter's input capacitor is considered as summation of the input capacitance C_{d1} of the piezoelectric transformer 104 and the sum of output capacitances of the first and second semiconductor switches S₁ and S₂, typically MOSFETs,

Cᵢₙ=2Cₒₛₛ+C_{d1} (1)

2) Negligible parasitic components;

3) Fundamental resonating of the piezoelectric transformer due to its high quality factor.

Therefore, Mason's lumped circuit is used to demonstrate operation of the piezoelectric power converter in terms of resonant current and switching voltages of the semiconductor switches S₁ and S₂ of the input driver 103. Resonant current is also illustrated to allow detailed investigation of the operating modes. Output capacitors of S₁ and S₂ and C_{d1} are considered to be the input capacitance of the input section of piezoelectric transformer 104 since parasitic capacitances of a MOSFET based semiconductor switch is typically much lower than C_{d1} or in the other hand they would be charged and discharged together in the dead-time period. Furthermore, the dead-time period is studied in detail below.

1) S₂ is in a conducting switch state or ON while S₁ is in a non-conducting switch state or OFF state: Time interval t₁₂−t₂. The input capacitance of the piezoelectric transformer 104 is fully discharged and essentially short circuited through the relatively small on-resistance of semiconductor switch S₂ which is a low-side switch of the input driver. At t₁₂ S₂ is turned on and resonant current Iᵣₑₛ freewheels through S₂ and changes direction at some point in time which is labelled as t_{1I}. There is a minor voltage difference across S₂ while it is conducting. At time instant t_{1I} the resonant current has crossed zero and changes direction from forward to reverse and the operation of the piezoelectric power converter is illustrated in two subintervals by plots a and b of FIG. 1A. Plot a and plot b show an equivalent circuit and a resonant current flow during each of these time intervals. The below listed set of equations (2) formulates the resonant current and the switching voltage at this interval.

$$\{ \begin{matrix}{V}_{F} ( t ) = 0 \\ {i}_{res} ( t ) = {I}_{pk} sin ( ω t - {φ}_{t} )\end{matrix} \qquad ( 2 )$$

2) Both S₂ and S₁ are in a non-conducting switch state or OFF: Time interval t₂−t₅. During this time interval both semiconductor switches are OFF and the resonant current keeps its direction in the reverse orientation going through C_{d1} to a voltage slightly above the positive DC supply voltage V_{DC} until a high-side body diode, i.e. the body diode 113a of MOSFET switch S₁, clamps the transformer input voltage V_{F} at V_{DC}. Plot c of FIG. 1A shows the equivalent circuit and current flow in this time interval and the set of equations (3) below describes the voltage and current waveforms.

$$\{ \begin{matrix}{V}_{F} ( t ) = \frac{{I}_{pk}}{{C}_{opt}} ( cos ( ω t - {φ}_{t} ) - cos ( ω {t}_{2} - {φ}_{t} ) ) + 0 \\ {i}_{res} ( t ) = {I}_{pk} sin ( ω t - {φ}_{t} )\end{matrix} \qquad ( 3 )$$

During time interval t₅−t₆, the high-side body diode 113a of MOSFET switch S₁ starts to conduct reverse resonant current. Therefore, the transformer input voltage V_{F} is clipped to the sum of diode voltage drop across the body diode and V_{DC}. This time interval is not requisite because C_{d1} is already charged sufficiently to produce ZVS or soft switching. Plot d of FIG. 1B shows the equivalent circuit and current flow in this time interval and the set of equations (4) below describes the voltage and current waveforms.

$$\{ \begin{matrix}{V}_{F} ( t ) = {V}_{DC} + {V}_{d} \\ {i}_{res} ( t ) = {I}_{pk} sin ( ω t - {φ}_{t} )\end{matrix} \qquad ( 4 )$$

3) S₁ is in a conducting switch state or ON while S₂ is in a non-conducting switch state or OFF: Time interval t₆−t₈. The high side MOSFET S₁ is conducting and the resonant current Iᵣₑₛ freewheels through S₁ to be provided to the piezoelectric transformer. There is in practice a minor voltage difference across the finite on-resistance of S₁ while conducing. At t_{2I} the resonant current Iᵣₑₛ has crossed zero or ground and changes direction from reverse to forward. The operation of the piezoelectric power converter is therefore illustrated in two subintervals by plots e and f of FIG. 1B. The plots e and f show an equivalent circuit and current flow during each of these time intervals. The below listed set of equations (5) formulates the resonant current and the switching voltage V_{F} during this time interval.

$$\{ \begin{matrix}{V}_{F} ( t ) = {V}_{DC} \\ {i}_{res} ( t ) = {I}_{pk} sin ( ω t - {φ}_{t} )\end{matrix} \qquad ( 5 )$$

4) Both S₂ and S₁, are in a non-conducting switch state or OFF: Time interval t₈−t₁₂. At time instant t₈ the high-side switch S₁ is turned off. During this interval both S₂ and S₁ are in OFF states and the resonant current Iᵣₑₛ keeps its direction in the forward orientation by being fed through the input capacitance C_{d1}. The input capacitance C_{d1} is discharged and the voltage across C_{d1} drops to a level slightly below ground until a low side body diode 113b of S₂ clamps at time instant t_{1I}. Plot g of FIG. 1C shows the equivalent circuit and current flow in this time interval and the set of equations (6) below describes the voltage and current waveforms of Iᵣₑₛ and V_{F}.

$$\{ \begin{matrix}{V}_{F} ( t ) = \frac{{I}_{pk}}{{C}_{opt}} ( cos ( ω t - {φ}_{t} ) - cos ( ω {t}_{8} - {φ}_{t} ) ) + {V}_{DC} \\ {i}_{res} ( t ) = {I}_{pk} sin ( ω t - {φ}_{t} )\end{matrix} \qquad ( 6 )$$

Time interval t_{1I}−t_{12:} At t_{1I} the low side body diode of S₂ starts to conduct forward the resonant current. Therefore, the transformer input voltage V_{F} is clipped at a level of one diode voltage drop below ground. This time interval is not requisite because C_{d1} is already discharged completely to produce ZVS or soft switching. Plot h of FIG. 1C shows the equivalent circuit and current flow in this time interval and the set of equations (7) below describes the resonant current and the switching voltage V_{F} during this time interval.

$$\{ \begin{matrix}{V}_{F} ( t ) = - {V}_{d} \\ {i}_{res} ( t ) = {I}_{pk} sin ( ω t - {φ}_{t} )\end{matrix} \qquad ( 7 )$$

As previously mentioned it is important to have a sufficient duration or length of the intervening dead-times periods between the alternatingly conducting switch states of the first and second semiconductor switches S₁ and S₂. The duration of each of these dead time periods have often been shorter or longer than required to provide optimal ZVS operation for the reasons discussed above. This situation causes so-called hard switching of the first and and/or second semiconductor switches S₁ and S₂ and leads to a marked increase of the power consumption of the driver circuit. FIGS. 2A) and 2B) show these situations in the steady state operation of the prior rat piezoelectric power converter 100 depicted schematically on FIG. 1.

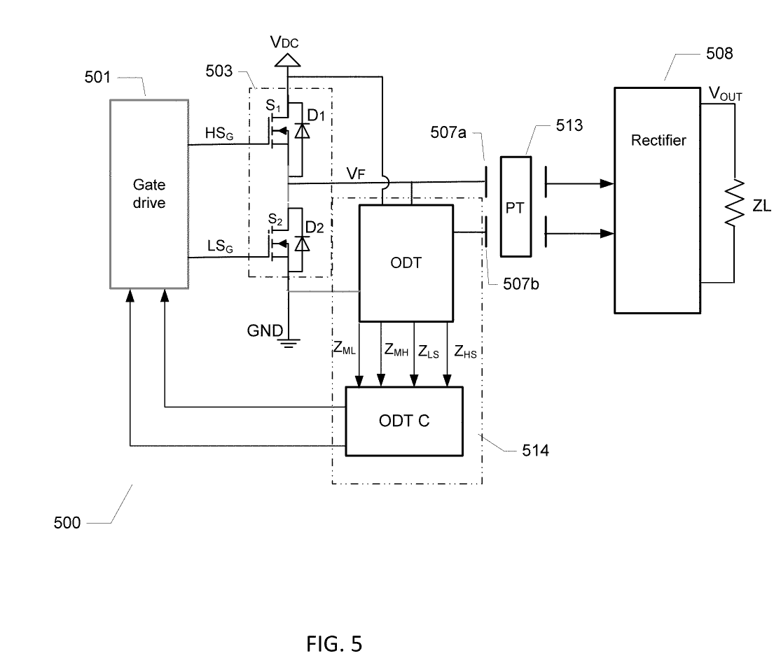

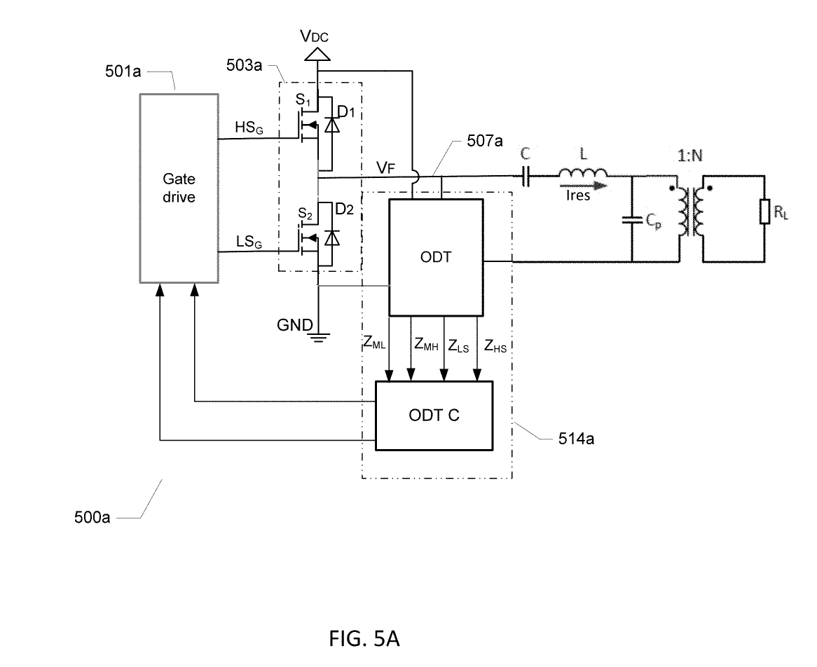

In contrast, the piezoelectric power converter 500 in accordance with the first embodiment of the present invention provides soft-switching of the first and and/or second semiconductor switches S₁ and S₂ of the driver circuit 503 by making an appropriate adaptation of the dead-time period of the driver circuit. In this manner, the dead-time may be adaptively adjusted to charge and discharge the input capacitance C_{d1} of the piezoelectric transformer 504 to the positive DC supply voltage V_{DC} and the negative DC supply voltage—for example ground or 0 V. FIG. 5 shows one embodiment of a piezoelectric power converter 500 in accordance with the present invention where a dead-time controller is configured to adaptively adjust a duration of the dead-time periods based on the transformer input voltage V_{F} as discussed in further detail below. In addition, FIG. 5A shows a magnetics based LCC topology of resonant power converter 500a in accordance with a second embodiment of the present invention where a dead-time controller is configured to adaptively adjust durations of the dead-time periods based on the resonant input voltage V_{F} as discussed in further detail below.

FIG. 2A) shows the situation where the dead-time period is shorter than optimum because the first and second semiconductor switches S₁ and S₂ are turned ON too early before the input capacitance C_{d1} is fully charged or discharged, respectively, to the DC supply voltage in question. This situation leads to hard switching of the driver circuit as shown by the respective waveforms 222a, 222b of the instantaneous transformer input voltage V_{F} and the corresponding resonant current Iᵣₑₛ.

FIG. 2B) shows the situation where the dead-time period is longer than optimal because the first and second semiconductor switches S₁ and S₂ are turned ON too late. This situation also leads to hard switching of the driver circuit as shown by the respective waveforms 223a, 223b of the instantaneous transformer input voltage V_{F} and the corresponding resonant current Iᵣₑₛ. In this case when the resonant current changes direction, the body diodes of the first and second semiconductor switches S₁ and S₂ are not conducting. This causes the input capacitance C_{d1} to discharge at time instant t_{2I} or being charged at t_{1I} before the semiconductor switches are turned on.

In prior art resonant power converters, such as piezoelectric power converters, the dead-time period has been a fixed time or value for the purpose of ensuring that ZVS operation is achieved in the steady state operation of the resonant power converter. This fixed dead-time period is normally longer than the optimal dead-time period discussed above. Another disadvantage of this fixed dead-time period is the build-up of resonant current is delayed during initialization or start-up of the prior art resonant power converter and it takes longer time for the converter to reach steady state operation. While this prolonged start-up time may seem rather insignificant in general, it becomes an important source of excess power consumption in resonant power converters that are turned on and turned off very frequently. This pattern of frequent turn off and turn off of the resonant power converter is for example utilized in so-called burst-mode control or quantum-mode control of the output voltage of the resonant power converter.

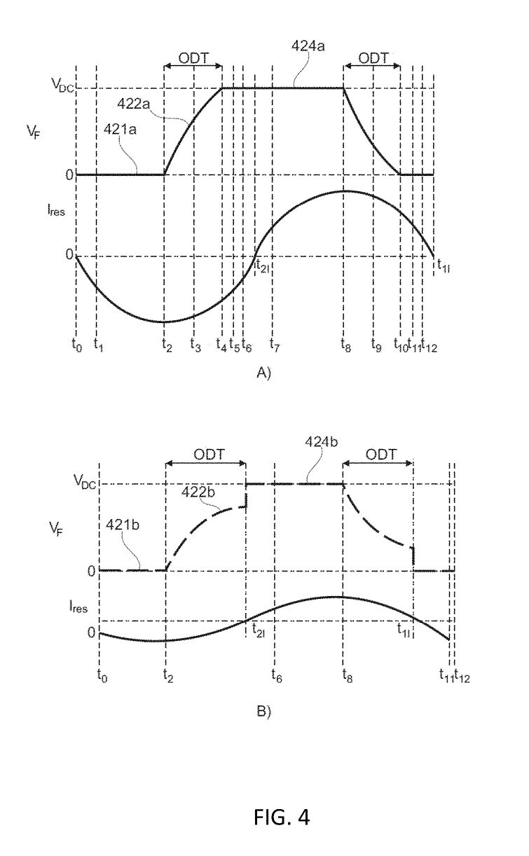

The present resonant power converter embodiments eliminate the cases shown in FIGS. 2A) and 2B) with too short or too long dead-time periods, compared to the optimal dead-time period. The piezoelectric power converter embodiment 500 depicted on FIG. 5 comprises the previously discussed dead-time controller OTD 514 which may dynamically detect and set an optimized dead time during every switching cycle of the transformer input voltage V_{F}. The operation of dead-time controller 514 optimizes, for example during each switching cycle, the time instants where the semiconductor switches S₂ and S₁ are switched from OFF to ON, i.e. turned on, to be placed substantially where the instantaneous transformer input voltage V_{F} reaches either the positive DC supply voltage or reaches the negative DC supply voltage during steady-state operation of the power converter. Furthermore, the dead-time controller 514 may also be configured to optimize the switching instants of the semiconductor switches S₂ and S₁ during the previously discussed initialization or start-up phase of the power converter. In the latter case, the operation of dead-time controller 514 optimizes, during each switching cycle, the time instants where the semiconductor switches S₂ and S₁ are switched from OFF to ON, i.e. turned on, to be placed substantially where the instantaneous transformer input voltage V_{F} reaches either a minima level or a maxima level. This may be accomplished by detecting or monitoring the waveform shape of the instantaneous transformer input voltage V_{F} as discussed in additional detail below. FIG. 4A) shows exemplary waveforms of the transformer input voltage V_{F} and resonant current Iᵣₑₛ of the piezoelectric power converter 500 during steady-state operation of the power converter 500. The two consecutive dead-time periods of the depicted single switching cycle of the transformer input voltage V_{F} are indicated by legend ODT. As shown by the waveform segment 422a, the transformer input voltage V_{F} increases monotonically from the negative DC supply voltage for ground (0 V) to the positive DC supply voltage V_{DC}. This increase of voltage is caused by the conducting state of the first semiconductor switch S₁ (and hence non-conducting state of S₂) which is pulling the transformer input voltage V_{F} towards V_{DC} via the small on-resistance of switch S₁. Likewise, the monotonically decreasing waveform segment 422b of the transformer input voltage V_{F} from the positive DC supply voltage V_{DC} to the negative DC supply voltage (0 V) is caused by the small on-resistance of switch S₂ which is pulling the transformer input voltage V_{F} towards 0 V or ground.

As shown in FIG. 1B), there are two dead time period periods or intervals in each switching cycle and these dead-time periods correspond to the time intervals t₂−t₆ and t₈−t₁₂ described above. Two time subintervals t₂−t₄ and t₈−t₁₀ are necessary to reach voltage across C_{d1} to the positive and negative DC supply voltage for obtaining ZVS operation of the driver circuit. In effect, the optimum dead time period is may reasonably be defined as a minimum time required for the resonant input voltage V_{F} to travel from one of the positive and negative DC supply voltages or rails to the other. Therefore, by detecting the time instants or points where the resonant input voltage V_{F} reaches either the positive or the negative DC supply voltage the time intervals t₄−t₆ and t₁₀−t₁₂ can be reduced to a minimum possible time. This is utilized in one embodiment of invention. On the other hand, optimizing the respective time intervals t₂−t₄ and t₈−t₁₀ is achieved by detection of time instant t₄ and detection of of time instant t₁₀ as shown in FIG. 4A). The latter detection allows the dead-time controller 514 to turn on the first and second semiconductor switches S₁ and S₂ at these time instants or points, respectively. This results in the setting of the optimum dead time period during each switching cycle of the resonant input voltage V_{F}. This feature results in fast and power efficient start-up of the resonant current Iᵣₑₛ by maximizing respective conducting state time periods of the first and second semiconductor switches S₁ and S₂ in order to feed energy into the resonant tank, e.g. including a primary side of the piezoelectric transformer, and build up resonant current.

The skilled person will appreciate that the detection of the time instants or points where the instantaneous transformer input voltage V_{F} reaches either the positive or negative DC supply voltage under steady state operation may be accomplished by different types of analog, digital or mixed-signal circuitry as discussed below in further detail. The previously discussed start-up phase or time period of the power converter designates the time period from power-on of the power converter to the time instant where the resonant current in the piezoelectric transformer reaches the maximum amplitude in the operating point of the power converter. During this start-up phase, the resonant current is growing continuously, but it does not reach the highest possible amplitude. Therefore, the input capacitance C_{d1} will not be charged all the way up to the level of the positive DC supply voltage or discharged all the way down to the level of the negative DC supply voltage.

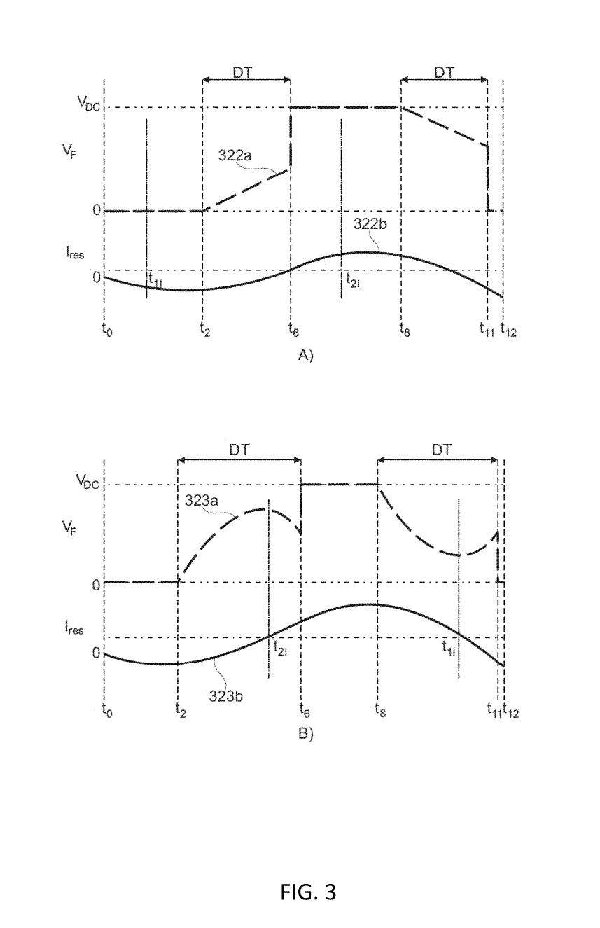

FIGS. 3A) and 3B) show exemplary voltage and current waveforms of V_{F} and Iᵣₑₛ during the start-up phase or period of the prior art power converter 100.

Accordingly, two different situations may be encountered during the dead time period DT in the start-up period: In a first situation, the instantaneous transformer input voltage V_{F} may pass through local maximum/minimum before the semiconductor switches are turned on. FIG. 3B) shows waveforms 323a, 323b of V_{F} and Iᵣₑₛ for this situation. The presence of the maximum/minimum or extrema in V_{F} at time instant t_{2I} of the waveform 323a is caused by a change of direction of the resonant current Iᵣₑₛ during the first dead time period DT as indicated by the zero-crossing of Iᵣₑₛ at the time instant t_{2I}. Therefore, the resonant current Iᵣₑₛ changes from charging to discharging the input capacitance C_{d1}. In the second situation, the transformer input voltage V_{F} is still increasing or decreasing until the first or second semiconductor switch S₁ or S₂ is turned on. This means that the transformer input voltage V_{F} will not pass through any local extrema. In this situation, the amplitude of the resonant current Iᵣₑₛ is too small to fully charge the input capacitance C_{d1}. This second situation is illustrated by the waveforms 322a, 322b of V_{F} and Iᵣₑₛ of FIG. 3A). The resonant current lies is changing direction during a switching cycle. The amplitude of the resonant current leads to the difference between the first and second situations which may be encountered during the start-up period. The resonant current lies is build up after power-on of the power converter and gradually increases in amplitude until the resonant current Iᵣₑₛ reaches a steady state amplitude. During steady state operation, the amplitude of the resonant current Iᵣₑₛ remains essentially constant provided the input voltage, temperature and load of the power converter also remain essentially constant. At the beginning of the start-up time period, the amplitude of the resonant current Iᵣₑₛ is so small that Iᵣₑₛ is unable to fully charge the the input capacitance C_{d1} during the dead time period to the positive DC supply voltage. This deficiency applies to both of the charging processes illustrated by FIG. 3A) and FIG. 3B). The optimal charging process may reasonably be considered reached by adapting the charging process of the input capacitance C_{d1} as illustrated by FIG. 4B). In the latter charging process the resonant current Iᵣₑₛ is near its peak amplitude at time instant t₂ when dead time period starts.

It can be shown that the total amount of energy provided to the input capacitance C_{d1} in the dead time period, defined as Δt=t₆−t₂, is:

$$Δ E = \frac{{I}_{pk}^{2}}{4 {C}_{in}} ( 1 - \frac{1}{2 ω Δ t} sin ( 2 ω Δ t ) ) \qquad ( 15 )$$

Therefore, it is important to turn on the first semiconductor switch S₁ or the second semiconductor switch S₂ at the zero crossing of the resonant current Iᵣₑₛ depicted on FIG. 4B). Consequently, to optimize the dead time period either during the start-up phase of the power converter or during the steady state operation thereof, one embodiment of the dead-time controller 514 may be configured to switch the first or second semiconductor switch to its conducting state either when the transformer input voltage V_{F} reaches one of the positive and negative DC supply voltages or when the resonant current Iᵣₑₛ crosses zero which ever condition occurs first. If neither of these conditions are detected the dead-time controller 514 may apply a fixed dead time period to facilitate build-up of the resonant current Iᵣₑₛ. The skilled person will understand that there is no direct access to detect or measure the resonant current Iᵣₑₛ inside the piezoelectric transformer 513. Therefore, the transformer input voltage V_{F} may conveniently be used by the dead-time controller 514 as a reference for detecting the dead time period in the piezoelectric power converter 500.

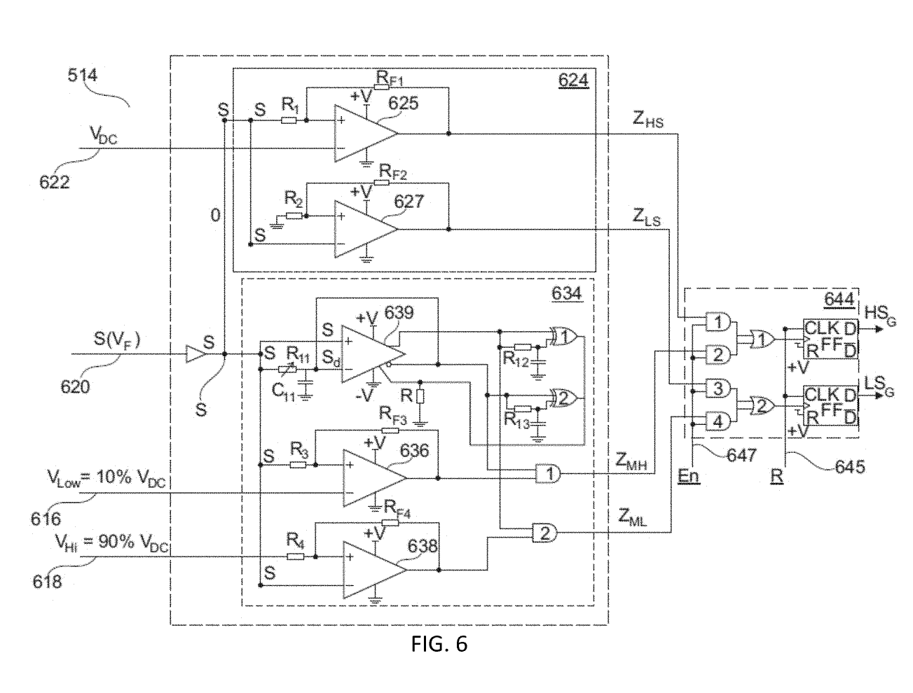

The LCC resonant power converter 500a of FIG. 5A in accordance with the second embodiment of the present invention likewise eliminates cases corresponding to those shown in FIGS. 2A) and 2B) with too short or too long dead-time periods of the resonant input voltage, compared to the optimal dead-time period. The LCC power converter 500a comprises a resonant network or circuit comprising first capacitor C and a first inductor L connected in series to the resonant input voltage V_{F} applied at the input terminal 507a of the resonant network. The resonant network additionally comprises a second capacitor Cₚ coupled in parallel across a primary side of a magnetic transformer with conversion ratio 1:N. Hence, the resonant voltage across the primary side of the magnetic transformer may be an output voltage of the resonant network. A secondary side of the magnetic transformer is coupled to a load R_{L}. Other embodiments of the resonant power converter 500a may comprise a rectification circuit coupled to the secondary side of the magnetic transformer to generate a DC output voltage of the LCC power converter 500a. A resonant current Iᵣₑₛ is flowing through the first inductor L of the resonant network to alternatingly charge and discharge the resonant input voltage V_{F} during successive dead-time periods of the half-bridge driver 503a. The LCC power converter 500a comprises a dead-time controller OTD 514a which may be configured to dynamically detect and set an optimized dead time period during every switching cycle of the resonant input voltage V_{F}. The operation of the dead-time controller 514a may optimize, during each switching cycle or at least a majority of switching cycles, the time instants where the semiconductor switches S₂ and S₁ of the driver 501a are switched from OFF to ON to be placed substantially where the instantaneous resonant input voltage V_{F} reaches either the positive DC supply voltage or reaches the negative DC supply voltage during steady-state operation of the LCC power converter 500a. This may be accomplished by adjusting the phase or timing of the first and second driver control signals HS_{G}, LS_{G} as discussed in detail below with reference to FIG. 6. Furthermore, the dead-time controller 514a may also be configured to optimize the switching instants of the semiconductor switches S₂ and S₁ of the driver circuit 503a during an initialization or start-up phase of the LCC power converter 500a. In the latter case, the operation of dead-time controller 514 optimizes, during each switching cycle, the time instants where the semiconductor switches S₂ and S₁ are switched from OFF to ON, i.e. turned on, to be placed substantially where the instantaneous resonant input voltage V_{F} reaches either a minima level or a maxima level during a dead-time period. This may be accomplished by detecting or monitoring the waveform shape of the instantaneous resonant input voltage V_{F} in a manner correspond to the one discussed in additional detail below with reference to FIG. 6. The operation and characteristics of the gate driver 501a and driver circuit 503a are also discussed in additional detail below with reference to the corresponding gate driver 501 and driver circuit 503 of the first embodiment of the resonant power converter 500.

FIG. 6 is a schematic block diagram of a preferred embodiment of the dead-time controller 514 of the piezoelectric power converter 500. The dead-time controller 514 comprises inter alia a steady-state controller 624 and a start-up controller 634 and a control circuit 644 (OTD C). The steady-state controller 624 is adapted to generate appropriately timed first and second driver control signals HS_{G}, LS_{G} for the for the half-bridge driver 503, delivered through the optional gate drive 501, and during steady-state operation of the power converter 500 and the corresponding first and second driver control signals HS_{G}, LS_{G} for the half-bridge driver 503a during steady-state operation of the LCC resonant power converter 500a. The start-up controller 634 is adapted to generate appropriately timed first and second driver control signals HS_{G}, LS_{G} for the half-bridge drivers 503, 503a during the initialization time or start-up time of the power converters 500, 500a. Hence, the first driver control signal HS_{G} switches the first or high side semiconductor switch S₁ between its conducting state and non-conducting state and the second driver control signal LS_{G} switches the second semiconductor switch S₂ between its conducting state and non-conducting state. Body diodes D₁ and D₂ are associated with the semiconductor switches S₁ and S₂, respectively, and may have the same function as the previously discussed body diodes 113a, 113b. Each of the first and second semiconductor switches S₁ and S₂ preferably comprises a MOSFET. The output of the driver circuit 503 supplies the transformer input voltage V_{F} since the output node of the driver circuit 503, i.e. the mid-point node between respective drain terminals of the MOSFET semiconductor switches S₁ and S₂, is coupled directly to a first input electrode 507a of an input section or primary side of the piezoelectric transformer 513. A second input electrode 507b of the primary side of the piezoelectric transformer 513 may be coupled to GND. The dead-time controller 514 is electrically connected to the transformer input voltage V_{F} and to the second input electrode 507b. The piezoelectric transformer 513 may further comprise a pair of output electrodes 508a, 508b electrically coupled to a secondary or output section of the piezoelectric transformer 513 and supply a transformer output voltage to an input of a rectification circuit 508. The rectification circuit 508 may comprise a half wave or full wave rectifier, and possibly output capacitor(s), to provide a smoothed DC voltage at an output node or terminal V_{OUT} of the piezoelectric power converter 500.

The steady-state controller 624 comprises a first comparator 625 configured to compare the instantaneous level or value of the transformer input voltage V_{F} to the positive DC supply voltage V_{DC}, fed through terminal or line 622, and supply a first comparator output signal Z_{HC}. The first comparator output signal Z_{HS} is utilized for adjusting the phase of the first driver control signal HS_{G} (please refer to FIG. 5) via the logic control circuit 644. The first driver control signal HS_{G} is applied to a control or gate terminal of the first semiconductor switch S₁ of the driver circuits 503, 503a. The steady-state controller 624 additionally comprises a second comparator 627 configured to compare the instantaneous level or amplitude of the transformer input voltage V_{F} to the negative DC supply voltage, which is ground (GND) or 0 V in the present embodiment, fed through terminal or line S, 623, and supply a second comparator output signal Z_{LS}. The second comparator output signal Z_{LS} is utilized for adjusting a phase of a second driver control LS_{G} (please refer to FIG. 5) via the logic control circuit 644. The second driver control signal LS_{G} is applied to the control or gate terminal of the second semiconductor switch S₂ of the half-bridge driver 503, optionally via the gate drive 501.

The skilled person will understand that the first comparator 625 is configured to detect the rising transit of the resonant input voltage, e.g. the instantaneous transformer input voltage V_{F}, associated with a low to high dead time period and adjust the duration of the low to high dead time period via the phase of the first driver control signal HS_{G}. In contrast, the second comparator 627 is configured to detect the falling transit of the resonant input voltage associated with a high to low dead time period and independently adjust the duration of the high to low dead time period via the phase of the second driver control signal LS_{G}. Hence, the low to high dead time periods and the high to low dead time periods are independently adjustable due to the independent detection and adjustment of the low to high dead time periods and the high to low dead time periods implemented by the separate comparators 625, 627 and supporting circuitry.

The start-up controller 634 is configured to detect a waveform shape of the transformer input voltage V_{F} and generate a first control signal Z_{MH} for adjusting the timing or phase of the first driver control signal HS_{G} via the logic control circuit 644 in accordance with the waveform shape of the transformer input voltage V_{F}. The start-up controller 634 is preferably also configured to detect a waveform shape of the transformer input voltage V_{F} and generate a second control signal Z_{ML} for adjusting the timing or phase of the second driver control signal LS_{G} via the logic control circuit 644 in accordance with the waveform shape of the transformer input voltage V_{F}. During the initialization period or start-up phase or period of the piezoelectric power converter 500, the instantaneous transformer input voltage V_{F} is applied at line or terminal 620, signal S, and compared with a delayed replica of the transformer input voltage S_{d}. The delayed replica of the transformer input voltage S_{d} is applied to a negative input of a third comparator 639 of the circuit 514. A local local maximum of the waveform of the instantaneous transformer input voltage is detected when S_{d}>signal S. Hence, the local maximum of the waveform of the instantaneous transformer input voltage during a dead-time period with increasing resonant input voltage is detected in response to, or when, the voltage of the delayed replica S_{d} exceeds signal S. Likewise, a local minimum of the waveform of V_{F} during a dead-time period with decreasing or falling resonant input voltage is detected when signal S<signal S_{d} (the delayed replica of the transformer input voltage). The skilled person will appreciate that the low to high dead time periods and the high to low dead time periods determined by the start-up controller 634 are independently adjustable due to the independent detection and adjustment of the low to high dead time periods and the high to low dead time periods implemented by the separate comparators 638, 636 and supporting circuitry.

The start-up controller 634 may furthermore limit the instantaneous transformer input voltage V_{F} between a predefined lower threshold voltage and a predefined upper threshold voltage before detecting the above-discussed local local maximum and minimum of the waveform of the instantaneous transformer input voltage. In the present embodiment, the start-up controller 634 is configured to set an intermediate or middle voltage range (M) between the predefined lower threshold voltage V_{Low} and the predefined upper threshold voltage V_{Hi} via the corresponding reference voltages applied through input lines or terminals 616 and 618 of the start-up controller 634. The predefined lower threshold voltage V_{Low} may for example be around 10% of the positive DC supply voltage V_{DC} such as between 0.05 and 0.2 times V_{DC} when the negative DC supply voltage is ground as in the present embodiment. The predefined upper threshold voltage V_{Hi} may for example be around 90% of the positive DC supply voltage V_{DC} such as between 0.75 and 0.95 times V_{DC}. These value ranges for the predefined lower and upper threshold voltages will provide a suitable noise margin for local extrema detection and prevent undesired triggering by noise impulses of the transformer input voltage. A fourth comparator 636 indicates whether the instantaneous transformer input voltage on line S is above the predefined lower threshold voltage V_{Low}. A fifth comparator 638 indicates whether the instantaneous transformer input voltage on line S is below the predefined upper threshold voltage V_{Hi}. The third comparator 639 may comprise a high precision dual/differential output comparator. As mentioned above, the output signals HS_{G}, LS_{G} of the ODT C block are controlled by the control circuit or block 644 in accordance with logic states of the input signals Z_{MH}, Z_{ML}, Z_{HS} and Z_{LS}. The first semiconductor switch S₁ is switched ON in response to either Z_{HS} or Z_{HM} is asserted such that HS_{G} is logically “1”. The second semiconductor switch S₂ is turned/switched ON in response to either Z_{LS} or Z_{ML} is asserted or digitally “1” such that LS_{G} is logically “1”. A reset control signal “R” through line 645 of the control circuit or block 644 is configured to selectively switching off the first and second semiconductor switches S₁ and S₂ after the allocated ON time period of the semiconductor switch in question. Finally, an optional enable signal “En” and function received through line 647 may enable/disable the operation of the dead-time controllers 514, 514a in the resonant power converters 500, 500a. The skilled person will understand that the respective voltage levels of references voltages such as V_{Hi}, V_{DC} and V_{Low} utilized in the dead-time controller 514 may be scaled to a voltage level of the comparators 625, 627, 639, 636, 638. The particular Boolean functions implemented in the dead-time controller 514 for the outputs of the steady-state controller 624 and the start-up controller 634 are:

$$\begin{matrix}\{ \begin{matrix}{Z}_{ML} = ( S < {V}_{Hi} ) \cdot ( S > {S}_{d} ) \\ {Z}_{MH} = ( S > {V}_{Low} ) \cdot ( S < {S}_{d} ) \\ {Z}_{HS} = ( S > {V}_{DC} ) \\ {Z}_{LS} = ( S < 0 )\end{matrix} & ( 16 ) \\ \{ \begin{matrix}{HS}_{G} = ( {Z}_{HS} + {Z}_{MH} ) \cdot En \cdot \overline{R} \\ {LS}_{G} = ( {Z}_{LS} + {Z}_{ML} ) \cdot En \cdot \overline{R}\end{matrix} & ( 17 )\end{matrix}$$

The steady-state controller 624 comprises the first comparator 625 which is configured to comparing the transformer input voltage V_{F} to the positive DC supply voltage V_{DC} via the positive and negative inputs of the first comparator 625. The positive input of the first comparator 625 receives the transformer input voltage V_{F} via line or terminal 620. The second comparator 627 is configured to comparing the transformer input voltage V_{F} to the negative DC supply voltage, i.e. 0 V via the positive and negative inputs of the second comparator 627.

Overall, the first and second semiconductor switches S₁ and S₂ are turned on, i.e. switched to the conducting state, by a rising edge of Z_{HS} and Z_{LS}, respectively, in the steady state operation of the resonant power converters 500, 500a. Likewise, the first and second semiconductor switches S₁ and S₁ are turned off, i.e. switched to the non-conducting state, by a falling edge of Z_{HS} and Z_{LS}, respectively, in the steady state. The same control scheme applies during the start-up or initialization period of the resonant power converters 500, 500a and the logic control block 644 determines whether first and second driver control signal HS_{G}, LS_{G} for the first and second semiconductor switches S₁ and S₂ are derived from the outputs of the steady-state controller 624 or the outputs of the start-up controller 634. Hence, each of the driver circuits 501, 503, 501a, 503a is configured to alternatingly pulling the resonant or transformer input voltage V_{F} towards the positive and negative DC supply voltages or rails via the first and second semiconductor switches S₁ and S₂, respectively, separated by intervening dead-time periods during each switching cycle in accordance the first and second driver control signals HS_{G}, LS_{G}.

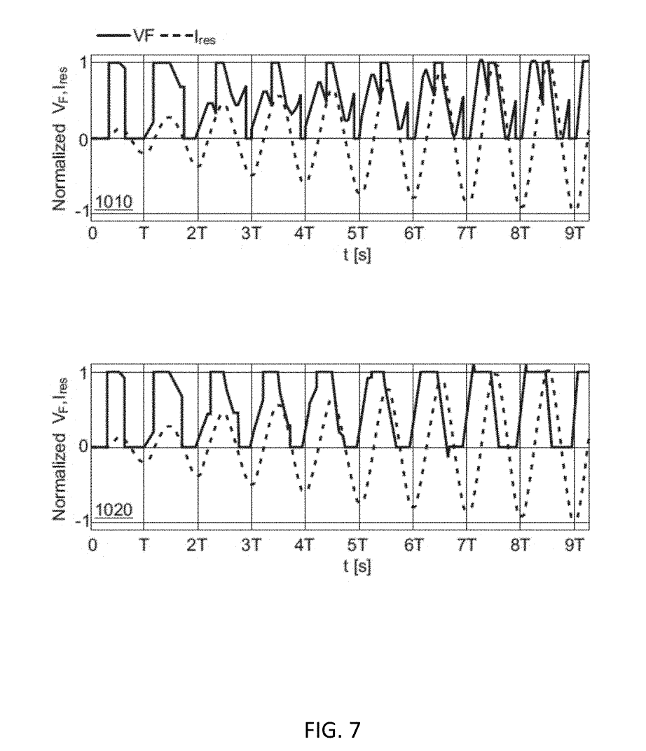

The lower plot 1020 of FIG. 7 shows experimentally measured normalized voltage and current waveforms of the transformer input voltage V_{F} and resonant current Iᵣₑₛ captured through several switching cycles of a start-up phase or state of the piezoelectric power converter 500 in comparison with the corresponding waveforms on the upper plot 1010 of the exemplary prior art piezoelectric power converter 100 depicted on FIG. 1A. The measurements were performed on a radial mode piezoelectric transformer with the following parameters:

| Parameter | Value | | Parameter | Value | |
|---|---|---|---|---|---|
| C_{d1} | 3.8 | nF | C_{d2} | 626 | pF |
| C | 565 | nF | R | 5.6 | Ω |

| | | | | |
|---|---|---|---|---|
| L | 3.5 | mH | N | 3.5 |

Furthermore, the fundamental resonance frequency of the radial mode piezoelectric transformer was 116.3 kHz and the load Z_{L} was a resistive load corresponding to 300 W of output power.

1. A resonant power converter comprising:
a first power supply rail for receipt of a positive DC supply voltage and a second power supply rail for receipt of a negative DC supply voltage,
a resonant network comprising an input section and an output section wherein the input section comprises an input terminal for receipt of a resonant input volt-age and the output section comprises an output terminal for providing a resonant output voltage in response to the resonant input voltage,
a driver circuit comprising a first semiconductor switch coupled to the positive DC supply voltage and a second semiconductor switch coupled to the negative DC supply voltage and a driver output connected to the input terminal for supply of the resonant input voltage;
wherein the driver circuit is configured for alternatingly pulling the resonant input voltage towards the positive and negative DC supply voltages via the first and second semiconductor switches, respectively, separated by intervening dead-time periods in accordance with one or more driver control signals,
a dead-time controller configured to adaptively adjusting the dead-time periods based on the resonant input voltage.

2. A resonant power converter according to claim 1, wherein the dead-time periods comprise low to high dead time period and high to low dead time periods;
wherein the dead-time controller is further configured to independently adjusting the low to high dead time periods and the high to low dead time periods.

3. A resonant power converter according to claim 1, wherein the first semiconductor switch comprises a conducting state where the input terminal of the resonant network is connected to the positive DC supply voltage and the second semiconductor switch comprises a conducting state where the input terminal of the resonant network is connected to the negative DC supply voltage; and
where the first semiconductor switch is in a non-conducting state during the dead-time periods and the second semiconductor switch is in a non-conducting state during the dead-time periods.

4. A resonant power converter according to claim 2, wherein the dead-time controller is configured:
to adjust a phase of a first driver control signal of the first semiconductor switch to adjust the low to high dead time period and a phase of a second driver control signal of the second semiconductor switch to adjust the high to low dead time period.

5. A resonant power converter according to claim 1, wherein the driver circuit comprises a half-bridge wherein the first semiconductor switch and the second semiconductor switch are coupled in series between the positive DC supply voltage and the negative DC supply voltage.

6. A resonant power converter according to claim 4, wherein the dead-time controller comprises a steady-state controller configured to adjust the high to low dead time period and the low to high dead time period during steady state operation of the resonant power converter.

7. A resonant power converter according to claim 6, wherein the steady-state controller comprises:
a first comparator configured to compare an instantaneous resonant input volt-age to the positive DC supply voltage and supply a first comparator output signal (ZHS) for adjusting the phase of the first driver control signal in accordance with the first comparator output signal,
a second comparator configured to compare the instantaneous resonant input voltage to the negative DC supply voltage and supply a second comparator output signal (ZLS) for adjusting the phase of the second driver control signal in ac-cordance with the second comparator output signal.

8. A resonant power converter according to claim 1, wherein the dead-time controller comprises a start-up controller configured to detect a waveform shape of the instantaneous resonant input voltage; and
generating a first control signal (ZMH) for adjusting the phase of the first driver control signal in accordance with the waveform shape;
generating a second control signal (ZML) for adjusting the phase of the second driver control signal in accordance with the waveform shape.

9. A resonant power converter according to claim 8, wherein the start-up controller is configured to detect the waveform shape of the instantaneous resonant input voltage by comparing the instantaneous resonant instantaneous transformer input voltage with a delayed replica of the resonant input voltage.

10. A resonant power converter according to claim 9, wherein the dead-time controller is configured to:
detect a local maximum of the waveform of the instantaneous resonant input voltage in response to the delayed replica of the resonant input voltage exceeds the instantaneous resonant input voltage;
detect a local minimum of the waveform of the instantaneous resonant input voltage in response to the delayed replica of the resonant input voltage falls below the instantaneous resonant input voltage.

11. A resonant power converter according to claim 9, wherein the dead-time controller is configured to limit the instantaneous resonant input voltage between a lower threshold voltage and an upper threshold voltage before detecting the local maximum or detecting the local minimum.

12. A resonant power converter according to claim 11, wherein the lower threshold voltage lies between 0.05 and 0.045 times the positive DC supply voltage and the upper threshold voltage lies between 0.55 and 0.95 times the positive DC supply voltage.

13. A resonant power converter according to claim 7, wherein the dead-time controller comprises a first digital OR circuit configured to logically OR the first comparator output signal and the first control signal; and
a second digital OR circuit configured to logically OR the second comparator output signal and the second control signal.

14. A resonant power converter according to claim 1, wherein the driver circuit and the resonant network are configured for ZVS operation or ZCS operation at the switching frequency of the resonant power converter.

15. A resonant power converter according to claim 1, wherein the driver circuit and the resonant network are configured for ZVS operation and/or ZCS operation at the switching frequency of the resonant power converter.

16. A resonant power converter according to claim 1, wherein the resonant network comprises a piezoelectric transformer;
wherein a primary section of the piezoelectric transformer is coupled to the resonant input voltage to supply a transformer input voltage and a secondary section of the piezoelectric transformer generates the resonant output voltage.

17. A method of adaptively controlling a dead-time interval of a driver circuit of a resonant power converter, comprising steps of:
generating first and second non-overlapping driver control signals for the driver circuit in accordance with a switching frequency of the resonant power converter, wherein the driver circuit is coupled between positive and negative DC supply voltages for supply of power,
applying the first and second non-overlapping driver control signals to the driver circuit to generate a driver output signal alternating between the positive DC supply voltage and negative DC supply voltage separated by intervening low to high dead time periods and high to low dead time periods,
applying the driver output voltage to an input section of the resonant network to generate a resonant input voltage,
generating a resonant output voltage in response to the resonant input voltage at an output section of the resonant network,
detecting a feature of the resonant input voltage,
adjusting durations of the low to high dead time periods based on the detected feature of the resonant input voltage and independently adjusting durations of the high to low dead time periods based on the detected feature of the resonant input voltage.

18. A method of adaptively controlling a dead-time period according to claim 17, wherein the instantaneous resonant input voltage is detected during each switching cycle of the switching frequency and the low to high dead time period and the high to low dead time period adjusted accordingly in response.

19. A method of adaptively controlling a dead-time period according to claim 17, further comprising:
adjusting a phase of a first driver control signal of the first semiconductor switch to adjust the low to high dead time period; and
adjusting a phase of a second driver control signal of the second semiconductor switch to adjust the high to low dead time period.
